(19) United States
(12) Patent Application Publication
(10) Pub. No.: US 2018/0213974 A1
(43) Pub. Date: Aug. 2, 2018

(54) SHIELDED AIRFLOW-REGULATED SMOKERS AND METHODS OF USING THE SAME

(71) Applicant: Masoud Mafi, Burlington (CA)

(72) Inventor: Masoud Mafi, Burlington (CA)

(21) Appl. No.: 15/417,487

(22) Filed: Jan. 27, 2017

(51) Int. Cl. A47J 37/07

(52) U.S. Cl. CPC A47J 37/0718; A47J 37/0786

(57) ABSTRACT

Smokers can enclose smoking subjects for production of trapped smoke with limited airflow. Optimal airflow rates and resulting smoking effects can be achieved through smokers. If a smoker has approximately 60 cubic inches volume, four 2-millimeter holes at an air inlet point achieves desired airflow and oxygen consumption in typical fills and cooking temperatures. Smokers include a lid or other seal or access point to permit placement and enclosure of smoking materials. A cover extends from the smoker to prevent entry of foreign material. Smokers are useable with conventional grills and may be shaped to sit on grill racks without blocking desired airflow by grill components or smoking materials. Smokers may include a detachable handle for safer handling and heating.

### BACKGROUND

Smoking is a known form of preparing food and other organic material wherein smoke, and often heat, are applied for cooking, flavoring, and/or preserving. Smoke can be formed from any combustion source, including a wood or charcoal fire, which may also provide heat, smoking chips or smoldering coals, or from food itself. Produced smoke may be trapped, such as in a smoking box or covered barbeque pit, for example, for exposure to the cooking object, or smoke may be directed onto the cooking object. Given a sufficient smoky atmosphere, organic material, including meats, vegetables, or any other food, can absorb and/or react with ash and incomplete combustion material in the smoke, adding flavor, color, and/or preservation qualities.

Known smoking devices that trap smoke include drum smokers, smoking pits, smoke houses, and smoking boxes. Smoking boxes are conventionally enclosures that can produce their own smoke but use an external heat source, such that they are useable with any ventilated cooking environment, including large commercial heating surfaces or smaller, conventional home charcoal, electric, or gas grills. For example, food and a smoking material, such as wood chips or pellets, can be placed in a smoking box and set on a gas, electric, or charcoal grill to provide heat. The smoking material smokes in the box from the heat, and the box traps the smoke such that the food is sufficiently exposed to the smoke. Conventional smoking boxes can include small openings in the top of the box to allow some rising smoke to escape, preventing any pressure buildup, while trapping the majority of smoke within the smoking box for exposure to food.

### SUMMARY

Example embodiments include smokers that can enclose a smoking material, such as pellets or wood chips, in a cavity that produces substantial amounts of smoke that can be exposed to food. A cover is attached at any point on the smoker, while permitting flow through the smoker. The cover prevents materials from falling into the smoker and causing flare-ups, extinguishing, and/or interfering with smoke exhaust and air flow. The resulting smoking without flaming may produce smoke to fill conventional gas or electric grills or barbeques for smoking food also placed therein. Desired airflow rates, such as only approximately 1.5E-5 to approximately 3.5E-5 oxygen grams per second per cubic inch volume of the smoker, can be achieved through natural convection and proper placement of air inlets and exhausts, or through forced airflow mechanisms like blowers, as well as spacing the cover away from the exhausts. For example, a smoker body of approximately 60 cubic internal inches may include an air inlet of four 2-millimeter holes where the body will contact the cooking surface or applied heat, with opposite exhaust openings. This example may achieve the limited oxygen availability and consumption rate through natural convection in typical cooking situations.

Example methods include smoking food by enclosing food in a smoky environment created by example smokers. For example, a smoking material can be placed in an example embodiment smoker and subjected to a heat source of about 200 degrees Fahrenheit or more, such as 600-700 degrees Fahrenheit. Food may be placed directly over example smokers without interference from dripping or separation due to the cover. Optionally, through control or design, oxygen flow of approximately 1.5E-5 to approximately 3.5E-5 grams of oxygen per second per cubic inch internal volume of the smoker can then be achieved through atmospheric or specially directed air. Example methods are useable with conventional grills and other heat sources, and with a variety of foods and smoking materials, including wood chips, pellets, etc. Example methods may further include attaching or removing a removable handle from example embodiments for safe handling.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the terms which they depict.

FIG. 1 is an illustration of a first example embodiment smoker.

FIG. 2 is a side view illustration of the first example embodiment smoker.

FIG. 3 is a top view illustration of a second example embodiment smoker.

FIG. 4 is a side view illustration of the second example embodiment smoker.

FIG. 5 is an illustration of the second example embodiment smoker.

FIG. 6 is an illustration of an underside of the second example embodiment smoker.

### DETAILED DESCRIPTION

This is a patent document, and general broad rules of construction should be applied when reading and understanding it. Everything described and shown in this document is an example of subject matter falling within the scope of the appended claims. Any specific structural and functional details disclosed herein are merely for purposes of describing how to make and use example embodiments. Several different embodiments not specifically disclosed herein fall within the scope of the appended claims; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to in a spatial or physical relationship, as being “connected,” “coupled,” “mated,” “attached,” or “fixed,” to another element, it can be directly connected or coupled to the other element or intervening elements may be present. In contrast, when an element is referred to as being “directly connected” or “directly coupled” to another element, for example, there are no intervening elements present. Other words used to describe the relationship between elements should be interpreted in a like fashion (e.g., “between” versus “directly between”, “adjacent” versus “directly adjacent”, etc.). Similarly, a term such as “communicatively connected” includes all variations of information exchange routes between two devices, including intermediary devices, networks, etc., connected wirelessly or not.

As used herein, the singular forms “a”, “an” and “the” are intended to include both the singular and plural forms, unless the language explicitly indicates otherwise with words like “only,” “single,” and/or “one.” It will be further understood that terms like “have,” “having,” “comprises,” “comprising,” “includes,” and/or “including,” when used herein, specify the presence of stated features, steps, operations, elements, ideas, and/or components, but do not themselves preclude the presence or addition of one or more other features, steps, operations, elements, components, ideas, and/or groups thereof.

It should also be noted that the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, so as to provide looping or other series of operations aside from the single operations described below. It should be presumed that any embodiment having features and functionality described below, in any workable combination, falls within the scope of example embodiments.

The Inventor has recognized that while smoking devices benefit from specific amounts of air through-flow, top-most openings required for such flow and exhausting of smoke may permit moisture or other material, such as drippings from food or preparation materials from above, to enter the smoking devices and limit smoking. For example, users may often use a smoker between a grill surface and heat source, such as a gas or charcoal burner, with foodstuffs being cooked on the grill surface. Water, oil, and/or food itself may drip or separate from the food and descend from the grill surface onto the smoker. These materials may block openings and air flow-through, as well as wet or smother the smoking material, like wood chips, preventing any combustion or optimized smoking. The materials blocking exhaust or entering the smoker through exhaust holes may be difficult to clean or remove, and may cause undesirable smell or poorly-flavored smoke. Example embodiments described below uniquely solve these and other newly-recognized problems by providing shielded smokers that still permit critical, limited oxygen intake for optimal smoking.

The present invention is a shielded smoking device that permits airflow through a relatively closed environment, and air/smoke outflow into a space where food is smoked, and well as methods of using the same. In contrast to the present invention, the small number of example embodiments and example methods discussed below illustrate just a subset of the variety of different configurations that can be used as and/or in connection with the present invention.

Co-owned patent publications 2013/0011535 and 2014/0154381, both for AIRFLOW-REGULATED SMOKERS AND METHODS OF USING THE SAME to Mafi are incorporated herein by reference in their entireties.

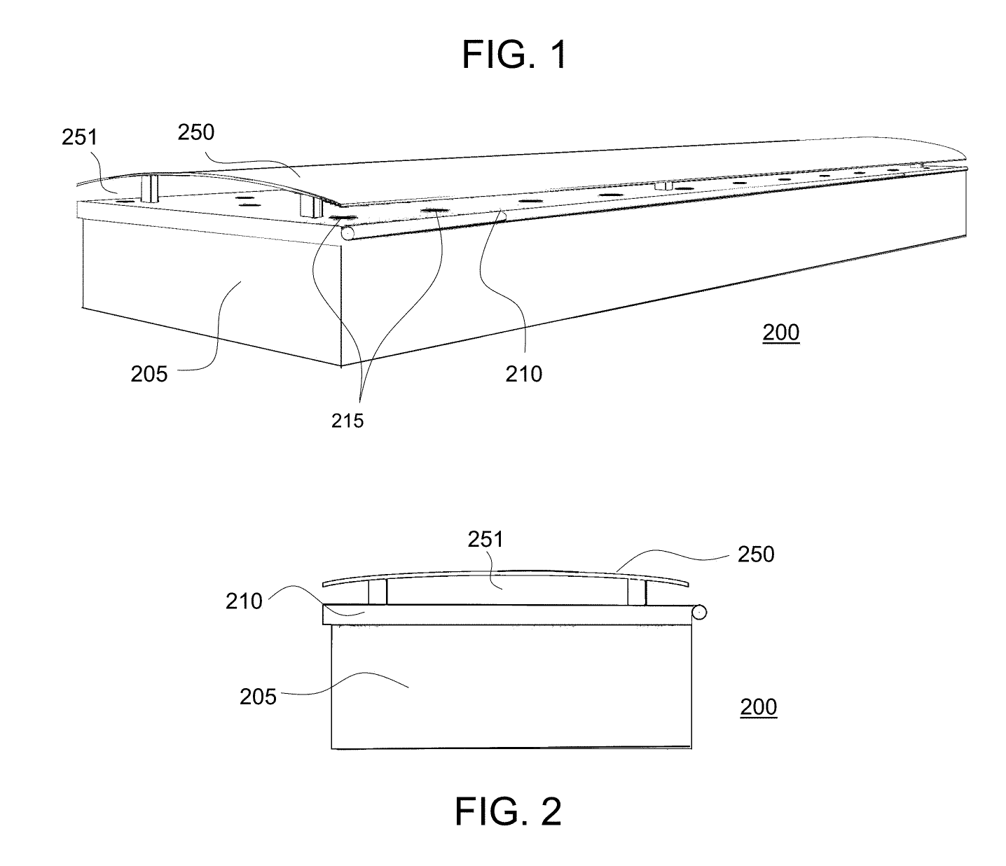

FIGS. 1-2 are illustrations of an example embodiment smoker 200. As shown, example embodiment smoker 200 includes a body 205 that defines a cavity into which smoking materials may be placed and substantially enclosed. As seen in FIG. 2, lid 210 may removably join to and enclose body 205; for example, when lid 210 is opened with a latch and rotated away from body 205 to which it may be hinged, a user may have access to the cavity inside body 205 to place material within body 105. Although lid 210 is shown hinged and closed against body 205 via a latch, it is understood that any useable opening can be used to access body 205, including a sliding cover, a screwable lid, a magnetically-attached cover, a body 205 that can be non-destructively disassembled and reassembled or otherwise opened, an access hole, etc.

Body 205 is shown in example embodiment smoker 200 as generally box-like, to sit flat on grilling racks and/or other heating surfaces. Likewise, body 205 can have other shapes and sizes that accommodate smoking materials and heat sources, including spheres or obloids, etc. Body 205 can be formed from any materials that are resilient to cooking conditions, including temperatures over 200 degrees Fahrenheit and/or direct flame exposure. For example, body 205 may be formed of a high-temperature glass, steel alloy, aluminum, ceramic composite, etc.

Smoker 200 includes at least one exhaust point located where combustion products and/or air through-flow may exit smoker 200 as smoke that fills a cooking area. For example, as shown in FIG. 1, smoker 200 may include several exhaust holes 215 near or on a top of smoker 200. Such exhaust holes 215 may be placed in lid 210, for example, at several points along a length of smoker 200 to permit even through-flow exhausting from body 205. Exhaust holes 215 may take on any shape or size that allows for desired exhausting, including slits, coverable slots, grids or meshes, tubes, etc. Or, for example, a single hole 215, or any other passive or forced exhaust mechanism, can be used with example embodiments.

Example embodiment smoker 200 may include at least one air intake point located where atmospheric or available air flow may enter smoker 200 at a desired rate. Because inlets are located at areas where air will flow into smoker 200, sizing and placement of apertures control the ultimate airflow, oxygen availability, and oxygen consumption rate within smoker 200 during typical cooking conditions. If body 205 has an interior volume of 60 in³, for example, apertures that result in an oxygen availability and maximum consumption rate of 0.002 g/s within body 205 when exposed to a cooking surface of 400 degrees Fahrenheit and average fill amounts cause optimized smoking conditions. Of course, several sizes, locations, and shapes of inlets may be used for differently sized or shaped bodies 205 to achieve desired oxygen consumption rates within other example embodiments using apertures to achieve desired flows.

In use, example embodiment smoker 200 may be loaded with desired smoking materials. For example, several coarse woodchips, for example, solid chips having a 0.3 porosity, or up to 0.7 fill, of body 205, of a desired flavor may be sealed into body 205 through lid 210. Smoker 200 is then placed on a heating surface or cooking environment where produced smoke can be trapped and air is available from a heat source. For example, smoker 200 may be placed on a lower level of a grill, or barbeque, or cooking pit, directly under food being cooked for maximum smoke sxposure.

As smoker 200 heats to cooking temperatures, the smoking materials begin to partially combust and smoke, typically over 200 degrees Fahrenheit and up to 600 or 700 degrees, and any foodstuffs begin to cook, including oxidize, pyrolize, denature, etc. Smoke may be produced at optimal rates in body 205, where it can escape at limited outflows through top exhaust slits 215 to provide ample smoking and flavor to a covered grill or barbecue, for example. Similarly, oxygen in ambient air flows in through inlet apertures at a limited rate of 1.5E-5 to 3.5E-5 g/s/in³ (6.5E-5 to 1.5E-4 g/s/in³ total air flow) through natural and/or driven convection between inlets and exhaust sholes 215, resulting in desired oxygen consumption, exhausting, and/or smoke production for foodstuffs from example embodiment smoker 200. After a desired cooking time, such as when foodstuffs exhibit a safe internal temperature or have a desired smoked appearance, food and/or smoker 200 can be removed from the enclosed smoky environment and the prepared foodstuffs may be consumed.

As shown in FIGS. 1-2, example embodiment smoker 200 further includes an exhaust cover 250 that prevents foreign materials from falling onto exhaust holes 215. Exhaust cover 250 may extend continuously across all exhaust points, such as continuously with lid 210, to which cover 250 may be attached. Cover 250 may be removably attached to lid 210 and securably movable with the same. For example, cover 250 may be bolted, magnetically attached, slide-locked, screwed, welded, and/or affixed by any other means to lid 210. Because exhaust cover 250 prevents material from vertically falling onto exhaust holes 215 or into body 205, such falling material may not interfere with the smoking of material in body 205. In this way, example embodiment smokers can be positioned directly under and proximate to cooking food, which may drip, separate, or fall onto the cover without blocking smoke flow or chemically interfering with smoke production.

As shown in FIGS. 1-2, exhaust cover 250 is separated from exhaust holes 215 by a gap 251 sufficiently large to permit unimpeded exhausting of flavorful smoke and air flowthrough in example embodiment smoker 200. Large amounts of flavorful smoke created by limited oxygen flow may still freely exit through gap 251 and smoke nearby foodstuffs that may be ejecting material onto cover 250.

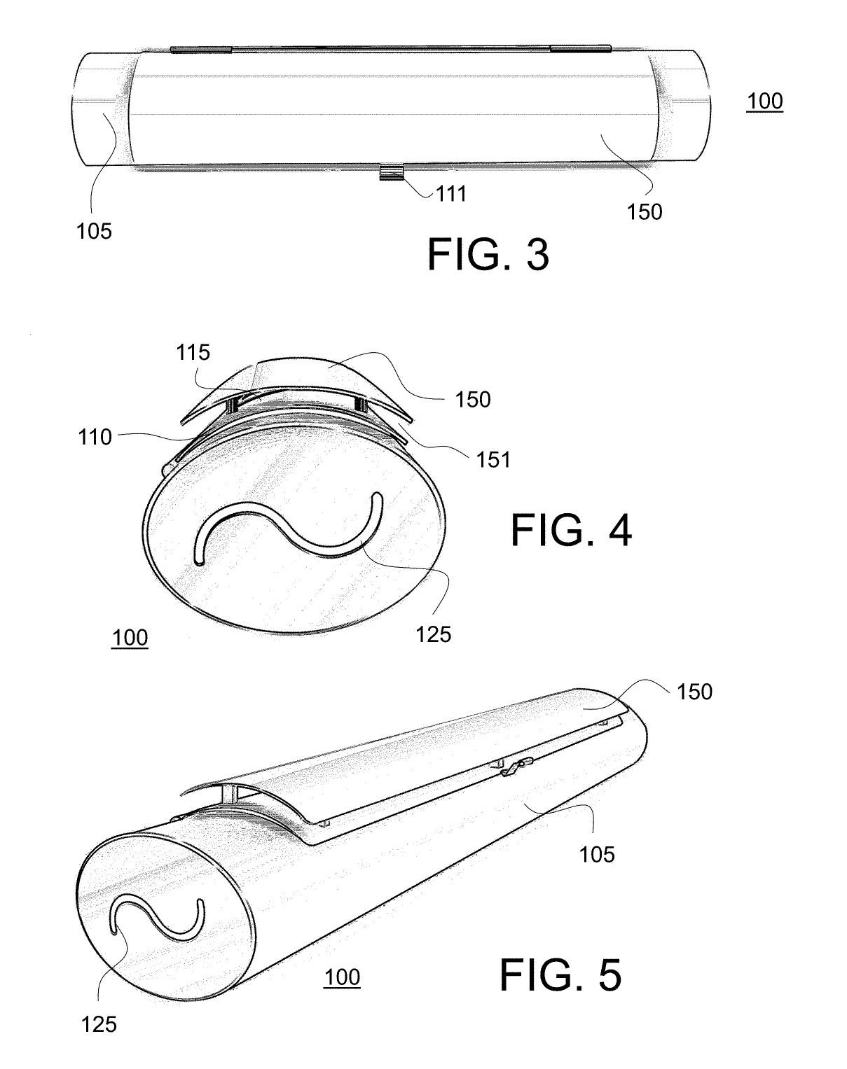

FIGS. 3-6 are illustrations of another example embodiment smoker 100. As shown in FIG. 3, example embodiment smoker 100 includes a body 105 that defines a cavity into which smoking materials may be placed and substantially enclosed. As seen in FIG. 4, lid 110 may removably join to and enclose body 105; for example, when lid 110 is opened with a latch and rotated away from body 105 to which it may be hinged, a user may have access to the cavity inside body 105 to place material within body 105. Although lid 110 is shown hinged and closed against body 105 via a latch, it is understood that any useable opening can be used to access body 105, including a sliding cover, a screwable lid, a magnetically-attached cover, a body 105 that can be non-destructively disassembled and reassembled or otherwise opened, an access hole, etc.

Body 105 is shown in example embodiment smoker 100 as generally elongate and elliptical/cylindrical, in order to accommodate grilling racks and/or other heating surfaces. Likewise, body 105 can have other shapes and sizes that accommodate smoking materials and heat sources, including prismatic boxes, spheres or obloids, etc. Body 105 can be formed from any materials that are resilient to cooking conditions, including temperatures over 200 degrees Fahrenheit and/or direct flame exposure. For example, body 105 may be formed of a high-temperature glass, steel alloy, aluminum, ceramic composite, etc.

Smoker 100 includes at least one exhaust point located where combustion products and/or air through-flow may exit smoker 100 as smoke that fills a cooking area. For example, as shown in FIG. 3, smoker 100 may include several exhaust slits 115 near or on a top of smoker 100. Such exhaust slits 115 may be placed in lid 110, for example, at several points along a length of smoker 100 to permit even through-flow exhausting from body 105. Exhaust slits 115 may take on any shape or size that allows for desired exhausting, including holes, coverable slots, grids or meshes, tubes, etc. Or, for example, a single slit 115, or any other passive or forced exhaust mechanism, can be used with example embodiments.

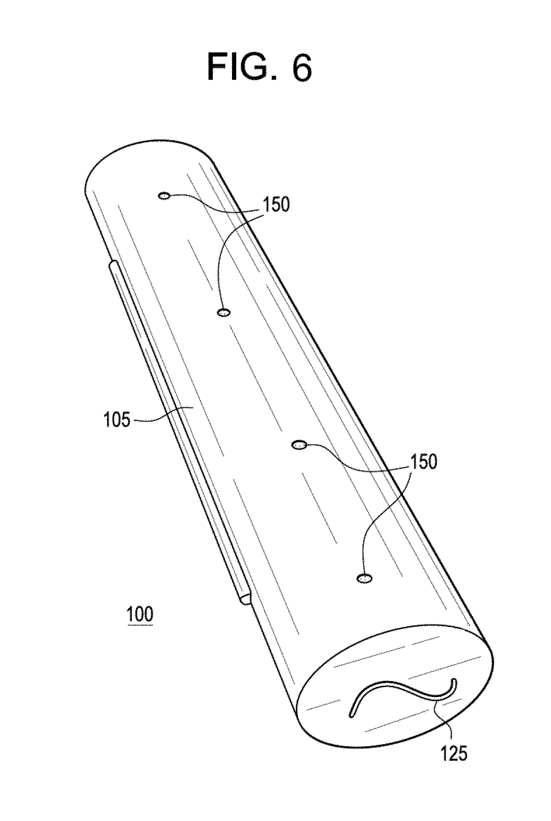

As shown in FIG. 4, example embodiment smoker 100 may include a second side with side exhaust slit 125 similar to exhaust slits 115 on top of smoker 100. Example embodiment smoker 100 further includes at least one air intake point located where atmospheric or available air flow may enter smoker 100 at a desired rate. For example, as shown in FIG. 6, four inlet apertures 150 may be placed along bottom surface 105 of smoker 100. Because inlet apertures 150 are located at areas where air will flow into smoker 100, sizing and placement of apertures 150 control the ultimate airflow, oxygen availability, and oxygen consumption rate within smoker 100 during typical cooking conditions. If body 105 has an interior volume of 60 in³, for example, four apertures 150 with diameters of approximately 0.079 inches or approximately 2.0 millimeters, will result in an oxygen availability and maximum consumption rate of 0.002 g/s within body 105 when exposed to a cooking surface of 400 degrees Fahrenheit and average fill amounts, resulting in the optimized conditions identified above. Of course, other sizes, locations, and shapes of inlet apertures 150 may be used for differently sized or shaped bodies 105 to achieve desired oxygen consumption rates within other example embodiments using apertures to achieve desired flows.

As shown in FIGS. 3-6, body 105 may include a curved lower surface with inlet apertures 150 positioned about a lowest point of body 105. Such positioning may permit example embodiment smoker 100 to be placed on a conventional grill grid, while contacting at least two grid crossbars, without significantly blocking apertures 150 by grill elements. Similarly, any smoking materials, which can be relatively coarse smoking chips, pellets, etc. placed within body 105 may not rest directly on apertures 150 due to their positioning in curved bottom surface of body 105, such that inlet apertures 150 are not significantly blocked. These features may aid in achieving desired air through-flows to body 105; of course, other shapes, sizes, and/or airflow-ensuring features can be used with body 105 while preserving this functionality.

In use, example embodiment smoker 100 may be loaded with desired smoking materials. For example, several coarse woodchips of a desired flavor may be sealed into body 105 through lid 110. As shown in FIG. 3, smoker 100 is then placed on a heating surface or cooking environment where produced smoke can be trapped and air is available from a heat source, such as a grill or barbecue or cooking pit, for example. As smoker 100 heats to cooking temperatures, the smoking materials being to partially combust and smoke, typically over 200 degrees Fahrenheit, and any foodstuffs begin to cook, including oxidize, pyrolize, denature, etc. Smoke is generally produced at optimal rates in body 105, where it can escape at limited outflows through top exhaust slits 115 to provide ample smoking and flavor to a covered grill or barbecue, for example. Similarly, oxygen in ambient air flows in through inlet apertures 150 at a limited rate of 1.5E-5 to 3.5E-5 g/s/in³ (6.5E-5 to 1.5E-4 g/s/in³ total air flow) through natural and/or driven convection between inlet apertures 150 and exhaust slits 115, resulting in desired oxygen consumption, exhausting, and/or smoke production for foodstuffs from example embodiment smoker 100. After a desired cooking time, such as when foodstuffs exhibit a safe internal temperature or have a desired smoked appearance, food and/or smoker 100 can be removed from the enclosed smoky environment and the prepared foodstuffs may be consumed.

As shown in FIGS. 3-5, example embodiment smoker 100 further includes an exhaust cover 150 that prevents foreign materials from falling onto exhaust slits 115. Exhaust cover 150 may extend continuously across all exhaust points, such as continuously with lid 110, to which cover 150 may be attached. For example, cover 150 may be bolted, magnetically attached, screwed, and/or affixed by any other means to lid 110. Exhaust cover 150 may be curved to follow the curvature of lid 110 and/or body 105 and facilitate materials falling onto the same rolling off. Because exhaust cover 150 prevents material from vertically falling onto exhaust slits 115 or into body 105, such falling material may not interfere with the smoking of material in body 105.

As shown in FIG. 4, exhaust cover 150 is separated from exhaust slits 115 by a gap 151 sufficiently large to permit unimpeded exhausting of flavorful smoke and air flowthrough in example embodiment smoker 100. For example, if body 105 has a 60 cubic inch interior volume, gap 151 may be half an inch or more to maintain oxygen flowthrough at 0.0009 to 0.0021 grams per second. Large amounts of flavorful smoke created by limited oxygen flow may still freely exit through gap 151 and smoke nearby foodstuffs that may be ejecting material onto cover 150.

An example embodiment thus being described, it will be appreciated by one skilled in the art that example embodiments may be varied and substituted through routine experimentation while still falling within the scope of the following claims. For example, although an example embodiment is described with an elongated body that control airflow through sizing and placement of openings, it is understood that example embodiments may include a wide variety of shapes and air-flow controls, including completely sealed boxes having forced oxygen inlets and exhausts as desired rates. Further, it is understood that example embodiments can be used in connection with any type of application where a smoking is useful to provide desired characteristics to a subject. Such variations are not to be regarded as departure from the scope of the following claims.

What is claimed is:

1. A smoker comprising:
a body defining an internal cavity sized to contain a smoking material, wherein,
the body includes at least one air inlet,
the body includes at least one exhaust point, and
the air inlet and the exhaust point exhaust smoke from partial combustion of the smoking material when heated in the smoker; and
a cover secured to the body, wherein the cover extends completely over and does not block the exhaust point so as to prevent falling material from blocking or entering the exhaust point.

2. The smoker of claim 1, wherein the body includes a plurality of exhaust points that are slits in a top of the body opposite the air inlet in a bottom of the body.

3. The smoker of claim 1, wherein the cavity has a volume of approximately 60 cubic inches, and wherein a flow is approximately 0.0009 to 0.0021 grams per second of oxygen when the smoker is heated in an atmospheric cooking environment over 200 degrees F. and the smoking material has a porosity of at least 0.3.

4. The smoker of claim 1, wherein the body is continuous and completely encloses the cavity with the exception of only the exhaust point, the air inlet, and an access point, the smoker further comprising:
a lid that removably encloses the access point, wherein the cover is secured to the body by directly attaching to the lid.

5. The smoker of claim 4, wherein the lid is attached to the body by a hinge and a latch.

6. The smoker of claim 1, wherein a bottom of the body is curved, and wherein the air inlet is at a bottommost point of the curved bottom surface.

7. The smoker of claim 1, wherein the body is an elliptic cylinder extending longest in a height direction.

8. The smoker of claim 7, wherein the exhaust point is four apertures spaced in the height direction along the bottom.

9. The smoker of claim 8, wherein the body has an internal volume of approximately 60 cubic inches, and wherein each of the four apertures has a diameter of approximately 0.08 inches.

10. The smoker of claim 1, further comprising:
an attachment point configured to receive a removable handle.

11. A smoker comprising:
a body defining an internal cavity of about 60 cubic inches, wherein at least one side of the body is solid except for only four 2-millimeter holes spaced along a length of the body so as to allow only a limited amount of oxygen into the body under atmospheric cooking conditions and prevent full combustion and enhance smoking of materials placed in the internal cavity, and wherein the body includes at least one exhaust point on another side; and
a cover secured to the body, wherein the cover extends completely over and does not block the exhaust point so as to prevent falling material from blocking or entering the exhaust point.

12. The smoker of claim 11, wherein the body is elliptical with a top and a bottom at opposite radial positions, wherein the body extends farthest in a height direction perpendicular to the radial, and wherein the air inlet and the exhaust point are across from one another.

13. The smoker of claim 12, wherein the air inlet includes a plurality of holes in the bottom spaced along the axial direction, and wherein the exhaust point includes a plurality of holes in the top spaced along the height direction.

14. The smoker of claim 13, wherein the body is an elliptical cylinder with a major axis and a shorter minor radial axis, and wherein the top and the bottom are on opposite ends of the minor radial axis.

15. The smoker of claim 14, wherein the exhaust point includes more openings than the air inlet.

16. The smoker of claim 15, wherein the body has an internal volume of approximately 60 cubic inches, and wherein each of the plurality of holes in the bottom has a diameter of approximately 0.08 inches such that a maximum oxygen flow rate into the smoker is 0.002 grams per second in the atmospheric cooking environment.

17. The smoker of claim 16, wherein the body includes a lid housing the openings, and wherein the cover is secured to, and spaced away from, the lid.

18. A smoker comprising:
a body defining an internal cavity, wherein the body includes at least one air inlet and at least one exhaust point opposite the air inlet in the body to permit flow into and out of the body; and
a cover secured to the body over the exhaust point, wherein the cover does not interfere with the flow.

19. The smoker of claim 18, wherein the body is an elliptical cylinder with a major radial axis and a shorter minor radial axis, and wherein the air inlet and the exhaust point are on opposite ends of the minor axis.

20. The smoker of claim 19, wherein the body includes a moveable lid to which the cover is directly attached.
